(19) United States
(12) Patent Application Publication
(10) Pub. No.: US 2011/0261131 A1
(43) Pub. Date: Oct. 27, 2011

(54) SUBSTRATE MOVEMENT IN A PRINTER

(75) Inventors: William Richard Eve, Cambridgeshire (GB); William Ronald Stuart Baxter, Cambridgeshire (GB)

(73) Assignee: INCA DIGITAL PRINTERS LIMITED, Cambridge (GB)

(21) Appl. No.: 13/125,543

(22) PCT Filed: Oct. 22, 2009
(86) PCT No.: PCT/GB2009/051426

§ 371 Date: Jun. 15, 2011

(30) Foreign Application Priority Data
Oct. 28, 2008 (GB) 0819785.7

(51) Int. Cl. B41J 2/01

(52) U.S. Cl. 347/104

(57) ABSTRACT

Apparatus is described for handling a print substrate in a printer. In examples described, the substrate is a web, for example a continuous web. A web support device is provided for supporting the web in a printing region and a web transport device is adapted to move the web forwards and backwards in the printing region. In examples described, multipass printing is carried out.

### CROSS-REFERENCE TO RELATED APPLICATIONS

This application is a National Stage of International Application No. PCT/GB2009/051426, filed Oct. 22, 2009. This application claims the benefit and priority of GB application 0819785.7 filed Oct. 28, 2008. The entire disclosures of the above applications are incorporated herein by reference.

### BACKGROUND

This section provides background information related to the present disclosure which is not necessarily prior art.

1. Technical Field

This invention relates to moving of substrates in a printer. Some aspects described herein relate to applications where the substrate includes a web, and to printing on a web. Aspects of the invention relate to printing onto reel-fed material and use of reel-fed material to move substrates in a printer. Preferred aspects of the invention relate to web feed devices for printers, for example for inkjet printers. In examples described, the devices find particular application in relation to industrial printers.

2. Discussion

There are many different types of printer which are used to print images onto a wide variety of different substrates. During printing, ink, or another printing medium, is ejected from a printhead arrangement and deposited onto a surface of the substrate. For the whole of the required image to be printed onto the substrate it is generally required for there to be relative movement of the printhead arrangement and the substrate.

In known printing systems, problems can arise in handling the substrates.

In some flat bed printers, a substrate is loaded onto a substrate bed, for example a table, which is reciprocated under an array of printheads during printing. Since the substrate is fixed relative to the table, this method can give good accuracy of printing and print quality. Advantages can also arise because the substrate to be printed is laid out on the table. For example, it is possible to perform certain printing techniques which seek to reduce printing artefacts such as banding and lawn stripes. Where the whole substrate is available for printing during the whole of the printing of the image, it is possible to set up schemes for printing the whole image, for example which seek to reduce the incidence of printing artefacts. For example, different areas of the image might be printed at different times and with different parts of the printhead array in predefined patterns to disguise or avoid printing artefacts. Also, in some arrangements, it is possible to lay down the print of an image and then apply a coating or other treatment to the printed image while it is still on the table. For example, where the image is printed using curable ink, a final cure step can cure the ink across the whole printed image. In other cases, it may be desirable to print the image as a series of layers, with one layer of printed image being laid down onto the substrate before the printing of a subsequent layer.

However, the use of flat bed printers can lead to inefficiencies in the printing. In particular, the loading and unloading of the substrates onto and off the table is time consuming and no printing can be carried out during this time.

In small format printers and office printers, it is common for the substrate to comprise individual sheets of, for example, paper. The paper or other substrate is provided as a stack and a sheet feeding mechanism is provided for removing individual sheets from the stack and feed the sheets to the printhead region. Such an arrangement is not generally practical for large format printers because of the large size of the substrates to be printed. Handling issues also can arise, in particular in relation to the handling of the printed sheets.

Providing a substrate in the form of a web of material is known. It is known to feed an “endless” web from a roll of material. The web is unwound from the roll and is passed to a printing station where the image is printed onto the substrate. In known arrangements, the printhead array is arranged to scan across the substrate web in a direction generally perpendicular to the direction of advance of the web material. In this way, print swathes of the image are printed transverse to the web advance direction. In such arrangements, the web might be supported, for example on a roller adjacent the printhead arrangement and/or a platen being a similar width to that of the printhead arrangement in a direction perpendicular to the direction of scanning. The web passes through the printer and the printed web is collected. The printing of the image in swathes can lead to the forming of printing artefacts, for example stripe or banding effects corresponding to the print swathes.

### SUMMARY OF THE INVENTION

Aspects of the present invention seek to overcome and/or mitigate one or more of the problems indicated above and/or other problems.

According to an aspect of the invention there is provided a substrate handling device for a printer including a printhead arrangement for printing onto the substrate in a printing region, wherein the substrate includes a web, and the device includes a web transport device adapted to move the web forwards and backwards in the printing region.

Preferably the web includes a continuous web.

By arranging for the web to be moved backwards as well as forwards in the printing region, greater flexibility of printing arrangements and printer operation can be achievable, for example as discussed further below.

Preferably the device further includes a web support device for supporting the web in the printing region. For example, the web support device may include spaced apart elements for example rollers, across which the web passes, and between which the web extends through the printing region. For example, the support device may include a substrate platen or bed on which the web is held for example adjacent the printheads in the printing region.

In some arrangements, the printheads are arranged to print directly onto the web itself. In other examples, substrate or substrates to be printed may be mounted onto the web.

The web may be include any suitable material of any appropriate weight, thickness or other property. For example, the web may comprise a paper or card, or may comprise a plastics sheet material, or may comprise a fabric or material for example a fibrous material which may be woven or non-woven. In arrangements where the web is reel-fed, preferably the web material is such that it can be rolled onto the reel, for example having reference to the flexibility of the web. The web may be suitable for printing to be carried out directly onto its surface. The web might be suitable for supporting a substrate element in the printer, the printing being carried out on a surface of the substrate element.

According to an aspect of the invention there is provided a substrate handling device for a printer including a printhead arrangement for printing onto the substrate in a printing region, wherein the substrate includes a reel-fed material, and the device further includes a transport device adapted to move the reel-fed material forwards and backwards in the printing region.

According to an aspect of the invention there is provided a substrate handling device for a printer including a printhead arrangement for printing onto the substrate in a printing region, wherein the substrate includes a strip of material, and the device further includes a transport device adapted to move the substrate material forwards and backwards in the printing region. In some aspects of the invention, the material might not be fed from a reel. For example, the material might be in the form of a strip or loop of material arranged to pass through the printing region.

Preferably the transport device includes a reel and in use the web is wound onto the reel and is fed from the reel into the printing region. Preferably the transport device includes a reel and in use the web is wound onto the reel and is fed from the printing region to the reel.

Preferably the transport device includes two reels, such that in use, the web is wound onto the two reels and extends between the two reels through the printing region, wherein rotation of a reel effects forwards and/or backwards movement of the web in the printing region.

Movement of the two reels of the reel-to-reel arrangement thus can allow the backward and forwards motion of the web. Preferably the two wheels are rotatable.

Thus backwards and forwards movement of the web in the printer is facilitated. Preferably they are independently rotatable. In some arrangements, when one wheel is rotated, the other might be free to rotate, or might be actively rotated.

Preferably the device further includes a tracking device for determining information relating to the movement of the substrate in the printing region. An optical tracking device might be used.

Preferably the device is adapted for use in a multipass printing method. Preferably the movement of the substrate can support a multipass printing method. For example, in each printed pass, different colours might be printed, and/or the resolution of the printed image might be increased. In some examples, all of the print colours might be printed in each pass, the backwards and forwards motion being to increase for example print resolution.

Preferably the web transport device is adapted to move the web a distance corresponding to the length of the image to be printed in a single pass. In this way, preferably the full length of the web onto which a particular image is to be printed passes through the printing region in the forwards and backwards movement in a multipass printing operation.

This image distance might be, for example in an industrial printer, more than 50cm, preferably more than 1 m, preferably more than 1.5 m, even 2 m or more.

Thus the full image can be addressed in each printing pass. This feature is particularly preferred in some arrangements as the whole image to be printed can be addressed in each print scan; this then allows certain printing techniques to be used, for example to improve print quality and/or reduce the effect of print artefacts. As an example, methods of printing seek to reduce the effect in a printed image resulting from a defective nozzle being present in the printheads. In known techniques, the printing of a pass is carried out by spreading the use of each nozzle across a large area of the image to be printed, for example substantially all of the image, rather than localising the problem to a particular area of the print where it might be more noticeable. By allowing the printheads to address substantially the full image during each pass, further such printing techniques and others become available when printing onto a web.

The invention also provides a method of printing in which the image to be printed is built up in layers of print. To do this most successfully, preferably the substrate handling system is such that substantially the whole of the image can be printed in a each pass.

Preferably the transport device further includes a resilient support member. Preferably the support member is such that it supports the web in the device. Preferably when the direction of the web reverses in the device, the resilient support member moves to reduce the risk of jarring of the web. Thus the use of one or more such support members can allow for faster reversal of the direction of movement of the web.

The support member may be resiliently mounted to allow for movement of the member. Alternatively or in addition, the support member might comprise elastically deformable material. Preferably a pair of one or more support members is provided to support web reversal in both directions.

In examples of the invention described herein, sets of festoons are provided.

Preferably the web support device is adapted such that the web is generally flat in the printing region.

The web support device may include a platen in the printing region. In some examples, a platen or bed will not be used. However, in other examples, the web may be supported on a bed or table during printing. Preferably the bed is generally flat, although in some examples a curved platen is described, for example the surface of a drum (see FIG. 6).

Preferably the platen if used is arranged to be under the printheads during printing. A negative pressure source might be provided to hold the substrate to the platen during printing. The platen might comprise a flat stationary table, or might for example include rollers, a conveyor belt or other element.

The platen might extend the full width of the web and/or the printing region (preferably a direction substantially perpendicular to the direction of movement of the web). In other examples, it may extend less than the full width. Preferably the platen extends substantially the width of the printhead array.

The web transport device may be adapted to move the web backwards and/or forwards during the printing of ink onto the substrate. By moving the web during printing through the print region, a large image area can be printed in a single pass, compared with the area of the printing region in the printer.

In other arrangements, the substrate could be stationary during printing, the substrate being indexed between print passes or scans.

The platen may extend a length being substantially the image length in the direction of movement of the substrate.

In this way, the full image can be printed onto the substrate without advancing of the substrate in the printing direction being required. This important feature is provided separately. Thus a further aspect of the invention provides a substrate handling device for a printer including a printhead arrangement for printing onto the substrate in a printing region, wherein the substrate includes a continuous web, and the device further includes a web support device for supporting the web in the printing region, the web support device comprising a support element having a support surface for supporting the substrate, and web transport device adapted to move the web through the printing region in a printing direction.

A broad aspect of the invention provides a substrate handling device for a printer including a printhead arrangement for printing onto the substrate in a printing region, the device further including a support element having a support surface for supporting the substrate in a printing region, and a substrate transport device adapted to move the substrate through the printing region in a printing direction. Thus in a broad aspect, the invention provides a printer having a substrate bed in the printing region, and means for feeding one or more substrates onto and off the substrate bed in the printing region. Preferably the substrate is in the form of a long or continuous strip of material. Preferably the substrate comprises a reel-fed material. The web may be arranged to transport substrate elements to and away from the printing region and/or within the printing region.

As indicated above the web may comprise any of a wide range of suitable materials depending on the arrangement used and whether or not the printing is to be carried out on a surface of the web.

An aspect of the invention provides a substrate handling device for a printer including a printhead arrangement for printing onto the substrate in a printing region, wherein the device further includes a support device for supporting a web in the printing region, the support device comprising a support element having a support surface for supporting the web, and web transport device adapted to move the web through the printing region in a printing direction.

Preferably the support surface has a size which is not less than the size of image to be printed by the printer. Preferably the support surface is sized so as to support all of a substrate to be printed. Thus the whole of the printable surface of the substrate is addressable by the printer on the support surface. Preferably substantially all of the area of the substrate to be printed is accessible during printing of the image. Thus several different techniques for reducing print artefacts are available and/or the printed image can be built up in layers of printing and/or a printed image can include fewer regions which need to be printed in separate printing operations. The web may comprise a continuous web.

The support surface may comprise the surface of a drum.

The support surface may be generally flat.

The support surface may extend substantially the full image length in the printing direction.

The length of the support surface may be significantly longer than the length of the printhead array in the printing direction.

In some arrangements described herein, a short bed is used. According to aspects of the present invention, a long platen being at least the length of the image to be printed is used.

Thus in some arrangements, the substrate movement device comprises a large format table, over which is moved a substrate including a web. Thus some examples of the invention are similar to a flat bed printer where instead of loading separate substrates onto the printer bed, a continuous web is used to more simply and quickly load the substrates to be printed onto and off the printer.

Considerably efficiencies in printer footprint and loading and unloading time can be achieved by some examples of the invention.

Preferably the device further includes a printhead arrangement, wherein the printhead arrangement is adapted to be moved in the printing direction.

The printhead arrangement may be adapted to scan the full image length in each pass. The arrangement may be adapted to carry out multiple scans, the printhead arrangement being indexed substantially perpendicularly to the printing direction between each scan. Alternatively or in addition, the printhead arrangement might extend across substantially the width of the substrate, the image being built up in layers on the substrate.

In such arrangements, the web might be stationary during printing, for example only being indexed once printing is complete. Alternatively or in addition, the web might be moved during printing in the printing direction.

The printheads might be arranged to scan across the substrate in a direction substantially perpendicular to the printing direction.

The printhead arrangement may include a plurality of nozzles, the nozzles being arranged in a substantially continuous array in a direction substantially perpendicular to the printing direction.

The printhead arrangement preferably includes a plurality of printheads.

The support surface may comprise a drum wherein the printable drum circumference is substantially the printed image length.

Thus the whole image can be printed by rotating the drum relative to the printheads (or moving the printheads around the drum circumference).

As indicated herein, the web can be advanced during printing, and/or between printing operations. The reels onto which the web is wound are preferably mounted within the drum.

The invention also provides a device described herein. Some aspects of the invention find particular application in relation to inkjet printers.

The printer may further include a radiation source for effecting cure of curable ink.

The printer may be adapted to print an image in multiple passes, each pass effecting the printing of a layer of the image.

Preferably each pass includes the printing of a layer comprising substantially the full area of the image.

According to the invention there is also provided a method of printing onto a substrate comprising a continuous web, the method including supporting the web in a printing region, and moving the web forwards and backwards in the printing region.

According to the invention there is also provided a method of printing onto a substrate comprising a continuous web, the method supporting the web in a printing region using a support element having a support surface for supporting the substrate, and moving the web through the printing region in a printing direction.

The method may include moving the web during printing.

Alternatively, the web is stationary during printing. The web can be indexed or moved between printing operations or scans.

The method may include printing substantially the length of the image in a single pass.

After each pass, the printheads may be indexed for printing a further pass to build up the image. In some arrangements, the printhead array will extend across the full width of the image, and thus

The image may be printed in a plurality of passes, each pass printing substantially a full layer of the image.

In this way, control of surface finish and other features of the printed image can be facilitated.

The method may further include supporting the web on a support surface in the printing region.

The method may further include supporting the web on a support surface extending substantially the full image length.

The method may further include moving the support surface during printing.

The support surface may include the surface of a drum and the method may include rotating the drum during printing.

A broad aspect of the invention provides a printer for printing on a web, the printer including a means for supporting the web in a printing region, and means for moving the web forwards and backwards in the printing region.

Where reference is made to a continuous web, preferably the web is sized so that a plurality of images can be printed onto its surface.

The invention also provides a method of printing being substantially as herein described preferably with reference to any of the accompanying drawings and a printer or substrate support device being substantially as herein described preferably with reference to any of the accompanying drawings.

The invention also provides a computer program and a computer program product for use in carrying out any of the methods described herein and/or for embodying any of the apparatus features described herein, and a computer readable medium having stored thereon a program for carrying out any of the methods described herein and/or for embodying any of the apparatus features described herein.

Any feature in one aspect of the invention may be applied to other aspects of the invention, in any appropriate combination. In particular, method aspects may be applied to apparatus aspects, and vice versa.

### BRIEF DESCRIPTION OF THE DRAWINGS

Preferred features of the present invention will now be described, purely by way of example, with reference to the accompanying drawings, in which:

FIG. 1 shows schematically a side view of a first example of a substrate feed and printing arrangement;

FIG. 2 shows schematically a control system for a printing arrangement of FIG. 1;

FIG. 3 shows schematically a side view of a second example of a substrate feed and printing arrangement;

FIG. 4 shows schematically a side view of a third example of a substrate feed and printing arrangement;

FIG. 5 shows schematically a side view of a fourth example of a substrate feed and printing arrangement; and

FIG. 6 shows schematically a side view of a fifth example of a drum-type substrate feed and printing arrangement.

The drawings described herein are for illustrative purposes only of selected embodiments and not all possible implementations, and are not intended to limit the scope of the present disclosure.

### DETAILED DESCRIPTION OF THE PREFERRED EMBODIMENTS

Example embodiments will now be described more fully with reference to the accompanying drawings

Corresponding reference numerals indicate corresponding parts throughout the several views of the drawings.

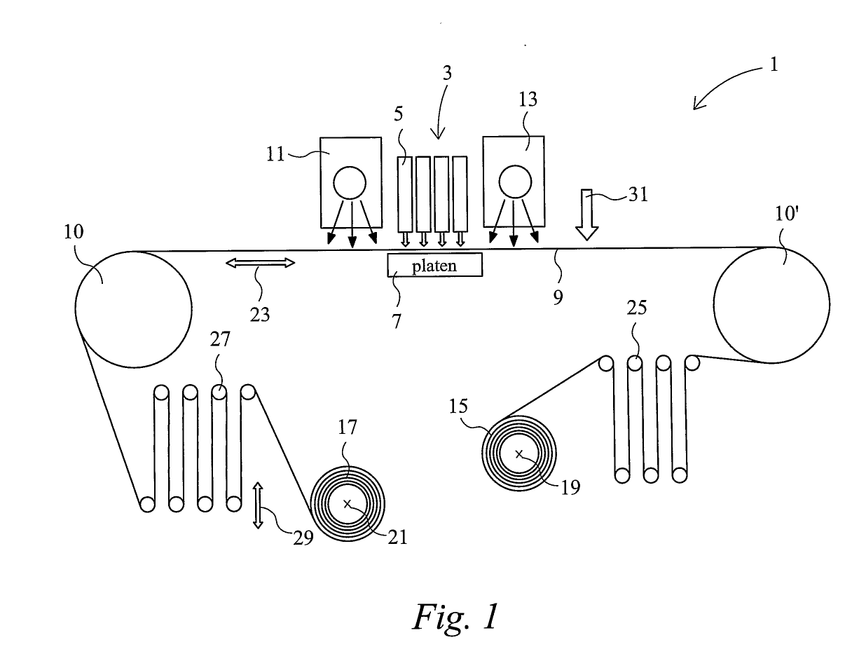

FIG. 1 shows a schematic side view of a first substrate moving device in a printer 1. The printer 1 includes a printhead arrangement 3 including a plurality of ink jet printheads 5 arranged so that the nozzles of the printheads 5 are positioned adjacent a platen 7.

A substrate 9 is arranged between the printheads 5 and the platen 7 and extends between two rollers 10, 10′ in a print direction which is generally parallel to the platen 7 and perpendicular to the nozzle arrays of the printheads 5. During printing, the substrate is moved relative to the printhead arrangement 3 in the print direction while ink is ejected from the printheads 5 onto the substrate 9 to form an image.

In this example, the ink is radiation-curable ink, for example UV-curable ink, and the printer arrangement further includes two radiation sources 11, 13. The radiation sources are arranged on either side of the printhead arrangement 3, being spaced apart in a direction substantially parallel to the direction of movement of the substrate past the printhead arrangement. During movement of the substrate in the printing operation, printed substrate having uncured ink on its surface passes under a radiation source 11, 13 which emits radiation towards uncured ink, the radiation having a wavelength and power suitable for effecting partial or full cure of the ink.

In this example, the radiation sources are mercury lamps, but other sources could be used, as appropriate. For example, in some arrangements, arrays of light emitting diodes could be used. The sources may include more than one type of source. Where two sources are used, they may be the same or different. For example, one source could be arranged to effect partial curing or setting of the applied ink; the other source could be arranged to effect a substantially full cure of ink.

The substrate 9 comprises a web of material, for example coated paper. The substrate may include card, a vinyl material for example PVC or an acrylic material for example PMMA.

In many arrangements, the web itself comprises the substrate to be printed. In other examples, the actual objects or substrates to be printed might be arranged onto a web of material, for example they might be releasably attached to the web.

The web of material extends between a supply reel 15 and a take up reel 17. The supply reel 15 and take up reel 17 each comprise a central generally cylindrical core onto which the web is wound. Each of the supply reel 15 and take up reel 17 are mounted in the printer 1 on a rotatable spindle 19, 21. Both of the spindles are rotatable both in a clockwise and counter clockwise direction; appropriate rotation of the spindle, relative to the direction of winding of the reel can unwind web from the reel or wind web onto the reel. A suitable mechanism (not shown) for effecting rotation of the spindles (19, 21) is provided. Preferably the movement of the supply and take up spindles 19, 21 are linked so that as the web is unwound from one of the reels, it is wound onto the other reel. In an alternative arrangement, one or both of the spindles 19, 21 can be rotated in a first direction to wind the web onto the relevant reel, and are freely rotating in the reverse direction to allow unwinding of the web when the web is being wound onto the other reel.

In this way, the web can be wound back and forth between one reel and the other. Festoons 25 are provided adjacent the reels 15, 17. The festoons 25 each comprise a set of small supporting rollers 27 around which a length of the substrate web 9 is wound. At least some of the small supporting rollers are movable. The movable rollers are biased to a home position in which a first length of substrate is wound in the festoon set but are movable 29 to allow the length of substrate wound in the festoon set to be decreased. This allows for faster web reversal within the printer.

Thus it can be seen that, during printing, the substrate can be moved backwards and forwards in two opposite directions in the printing direction 23.

In a first example of a printing operation for the substrate arrangement shown, the width of the printhead arrangement 3 transverse to the printing direction 23 is less than that of the image to be printed.

During printing, the spindle 21 is turned to wind the web onto reel 17 and thus the substrate is moved in the printing direction 23 while ink is deposited by the printheads 5 to form a first print swathe on the substrate. During the first print pass, the radiation source 13 which is behind the printhead arrangement 3 when printing in this direction effects a partial cure of the deposited ink. (In other arrangements, a full cure of the ink at this stage might be effected.)

When this first print scan has been completed, the rotation of the spindle 21 is stopped, the printhead arrangement is indexed in a direction perpendicular to the printing direction 23, and the spindle 19 is activated to wind the web onto the reel 15. Thus the direction of movement of the substrate is reversed and a second printing pass is carried out on the same length of the substrate as the first, laying down a second swathe of ink adjacent and/or overlapping the first swathe. During this second pass, the other radiation source 11 which is now located behind the printhead arrangement 3 effects a partial cure of the printed ink. Where the radiation sources extend across the whole width of the substrate, it will be seen that the source 11 will also effect a further cure of the ink of the first swathe. Alternatively, one or more of the sources may have a width less than that of the image to be printed. In this case the sources may also be indexed with the printheads. It may be necessary for one or more passes to be carried out (without ink being deposited) and/or further radiation sources to be provided to effect full cure of the ink.

Further swathes of ink are printed onto the substrate in a similar manner until the full image has been deposited on the region of the substrate.

Once the ink on the substrate has been fully cured, the web may be advanced to wind the substrate onto one of the rollers 15, 17 and to expose a new section of the substrate for printing. Alternatively, for example where the actual object being printed is supported by and/or attached to the web during printing, the printed object can be removed from the web and a further object for printing can be loaded onto the web.

In a second example based on the arrangement of FIG. 1, the printheads 5 extend substantially across the full width of the substrate to be printed. The general operation for printing a swathe of ink on the substrate is the same as described above for the first example. However, in this case, the full width of the image is printed in the first pass. For printing the second pass, the printheads might not be indexed, or may be indexed a small distance perpendicular to the printing direction before subsequent passes are carried out.

Thus it can be seen that in this second example the image is built up in layers, each layer being substantially the full width and length of the image to be printed. By this method, the risk of print artefacts, for example striping, due to the image being built up in adjacent or overlapping swathes, can be reduced and/or eliminated.

Also, it is possible for different printing and or curing parameters to be used for separate printed layers. In this way, the properties of the printed image can be controlled without significantly increasing the risk of undesirable print artefacts.

There may be some indexing of the printheads between each layer being printed. In this way, the layers of a particular portion of the substrate can be printed using different parts and/or nozzles of the printhead arrangement, therefore reducing the risk and/or effect of print defects for example as would arise in the case of a defective nozzle in the printheads. Preferably the distance of indexing of the printheads is less than about 10%, preferably less than about 5% of the width of the printhead array.

In a third example the arrangement of FIG. 1, the printed image can be printed in a single pass of the substrate past the printhead arrangement. In such examples, the web might be moved in only one direction through the printer.

It will be seen that the arrangement of FIG. 1 allows long images to be printed onto a web, with single pass printing being a possibility. Long images can be built up in layers, while giving a relatively compact feed arrangement compared with, for example, a flat bed printer for printing similar-sized images.

Where reference is made to the printhead arrangement in relation to this or other examples, it should be understood that any appropriate arrangement of printheads could be used and that the examples of the invention are not restricted as to the type or number of printheads which could be used.

The arrangement shown in FIG. 1 is given only as an example. The printheads may be arranged such that the nozzle rows are substantially perpendicular to the printing direction, or the nozzle rows may be angled differently. The printheads may inherently provide differently angled nozzle rows and/or the printheads themselves might be angled at a position between the printing direction and the perpendicular direction.

The printheads may be arranged in a single group, or more than one group may be provided the printer; each group might be associated with a radiation source, and/or a single source may be provided for more than one group.

Each printhead arrangement or group may comprise printheads for printing ink of more than one colour.

Multiple printheads of each colour may be provided in any suitable arrangement. More than one row of printheads may be provided; the rows may be staggered. Preferably the rows are arranged so that the nozzle array for a particular colour is substantially continuous in a direction perpendicular to the printing direction. By arranging for staggered rows of printheads, any gaps in the nozzle array caused by a gap between adjacent printheads might be avoided.

Where the substrate is moved backwards and forwards during printing, it will be important for the position of the substrate to be tracked so that each swathe can be printed in the correct position on the substrate compared with previous ones.

In the arrangement of FIG. 1, a tracking device 31 is provided. This may comprise an optical tracking device which monitors any movement of the web sideways and/or monitors the movement of the web in the printing direction. For example, the upper surface of the substrate may include a clock track comprising periodic markings on the surface. By detecting the passing markings as the web moves, the position of the substrate can be determined.

The position of the tracking device 31 in the printer will be chosen as appropriate.

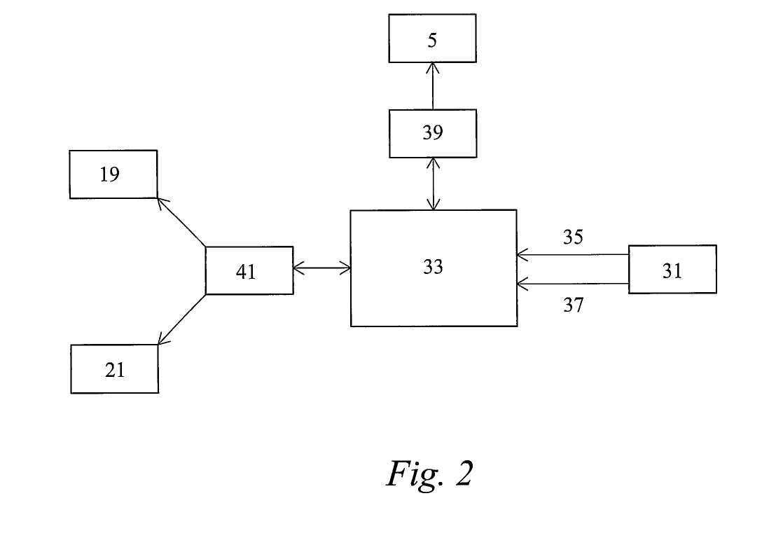

FIG. 2 shows schematically an example of a control system for controlling the movement of components of one or more of the arrangements described herein.

A central control unit 33 receives input from the optical tracking device 31 regarding the position of the web in the printing direction, input 35, and/or perpendicular to the printing direction, input 37. It will be appreciated that these inputs may come from one or more different tracking units of any appropriate type. Control unit 33 is also in communication with one or more printhead control units 39 which control the movement of the printheads during printing to effect the desired image.

Information received from the tracking device 31 is processed by the control unit 33 and any adjustment regarding the movement of the printheads, for example in response to a sideways movement of the web is calculated and transmitted to the printhead control units 39 for execution.

In addition, information received from the tracking device 31 may be used to identify starting conditions for the initial placement of the printheads relative to the substrate.

The control unit 33 is further in communication with the spindle control device 41 for controlling the movement of the spindles 19, 21 which effect the movement of the web reels 15, 17 and thus the movement of the web.

Information from the tracking device 31 regarding the movement of the web is processed by the control unit 33 and any adjustment regarding the movement of the web, for example in response to a stretching of the web or slipping on the rollers 10, 10′. Information from the tracking device 31 also can be used in the initial placing of the web prior to the printing operation being carried out. For example, the position of the substrate to be printed on the web can be identified.

One possibility is that the clock track or other monitoring markings are printed onto the substrate and/or web in a first printing step before the image is printed.

The control device described in relation to FIG. 2 is only an example and it will be understood that different arrangements would be possible to carry out the necessary control functions.

In the arrangement of FIG. 1, a platen 7 is provided to support the substrate web 9 during printing. The platen 7 is optional. The platen 7 is arranged in the region of the printheads 5 so that the substrate can be supported where the ink is being deposited. In the arrangement shown in FIG. 7, the platen is approximately the same length in the printing direction as the length of the printhead array 3 in that direction.

The platen 7 may comprise a table for example a flat bed. A vacuum or negative pressure source may be provided which may hold the substrate/web to the platen, for example by drawing air through holes in the platen surface. Other arrangements are possible. For example, the platen 7 may be provided by a movable support, for example a conveyor belt and/or rollers, with or without a vacuum or negative pressure source.

The support may assist the movement of the substrate, for example the movable support may be driven, for example linked with the driving of the reels in the arrangement of FIG. 1.

In the arrangement of FIG. 1, the platen 7 extends the full width of the substrate so that the substrate is supported in the area being printed during each printing operation. Alternatively, the platen 7 might be shorter than the width of the substrate width to be printed. The platen 7 might then be movable transversely in correspondence with the movement of the printheads.

In the following examples, a platen is used which extends in the print direction.

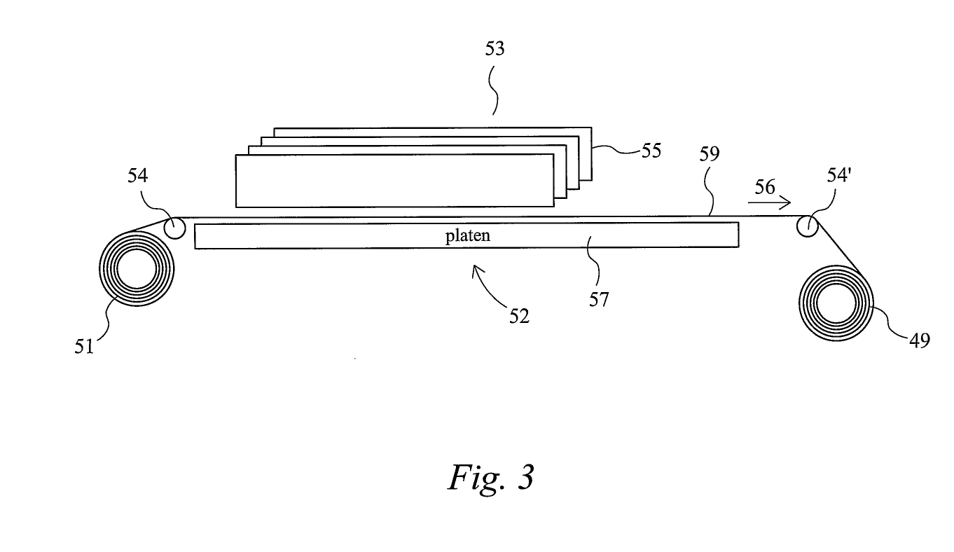

FIG. 3 shows a further printhead and substrate arrangement for a printer.

As before, the substrate to be printed is in the form of a web 59. Alternatively, the substrate to be printed may be applied to the web for printing. The printer includes a platen 57 and a printhead arrangement 53 adjacent the platen. The printhead arrangement includes four sets of printheads 55 arranged in a generally parallel array.

The web 59 is wound onto supply and take up reels 49, 51 mounted within the printer. Between the reels 49, 51, the web extends through a printing region 52 between the printhead arrangement 53 and the platen 57. Guide rollers 54 54′ are arranged at the ends of the platen 57 to guide the web 59 between the platen 57 and the reels 49, 51. By winding the reel 49 and/or 51 (by means of spindles not shown), the web 59 can be moved through the printing region 52 in the printing direction 56.

In contrast to the layout of FIG. 1, the printheads 55 of the present arrangement are such that the nozzle rows of the printheads extend in a direction generally parallel to the printing direction 56. Thus, in this arrangement, printing occurs during the scanning of the printhead arrangement 53 in a direction generally perpendicular to the printing direction 56.

In a preferred operation of the printer arrangement of FIG. 3, the platen 57 extends substantially along the whole width of the printhead arrangement 53 in the printing direction. Preferably the platen is greater in size than the image to be printed and the size of the printhead arrangement 53 is such that substantially the whole of the image area can be printed in a single scan of the printheads 55. Thus, as described in relation to FIG. 1, the image can be printed in layers of ink as multiple scans of the printhead arrangement 53 are made.

The printhead arrangement may print only in one scanning direction, or in both forward and reverse scanning directions. Radiation sources may be provided adjacent the printheads, for example as described in FIG. 1 so that the deposited ink can be cured or partially cured.

The printhead arrangement will be indexed in the printing direction between scans to fill the full printing grid and/or to reduce the appearance of any print artefacts. Curing and/or printing parameters may be utilised for each scan or for a set of scans so as to give the desired print quality, for example gloss or matt of the final printed image.

Once the full image has been printed, the web is advanced in the printing direction 56 to present a new substrate area to the printing region 52.

In preferred arrangements, the web is not moved until the printing of the image is complete. Alternatively, the web might be moved during printing. For example, instead of the printhead arrangement 53 being indexed between scans, the web might be indexed in the printing direction 56 between scans.

It is preferred that the size of the platen and printhead arrangement 53 is such that substantially the full image area can be printed in a single scan of the printheads. In this way, the benefit of printing the image in ink layers can be realised. However, it will be seen that the printer arrangement of FIG. 3 can be used in different ways. For example, images larger than the platen can be printed by movement of the web during the printing operation and/or images smaller than the platen size can be printed.

While a substrate tracking system, for example an optical tracking system may be used to determine information regarding the position of the substrate web, such a system is not necessary, in particular where the web is not moved during the printing of an image. Thus the image may be accurately printed onto the substrate, in particular where there is no movement of the web during the printing of the image.

A control system similar to that of FIG. 2 may be used for the operation of the printer arrangement of FIG. 3. The optical tracking device may or may not be used.

In some examples using the arrangement of FIG. 3, the length of image printable is limited by the length of the array, unless the image is printed in more than one area, thus leading to the risk of printing artefacts. Also, a large movement of the printheads is required compared with the arrangement of FIG. 1. Where the heads are indexed between scans, then two axes of movement of the printhead arrangement 53 is necessary, adding to the complexity of the printer.

However, because the web is not moved significantly during printing of the image in some examples, then the accuracy of printing can be high. Also, substrates mounted onto the web can be successfully be printed. For example, rigid objects can be loaded onto the web 59, for example from a stack of objects and/or from a previous printing o treatment station. The object is moved supported by the web 59 into the printing region 52. After printing, the object supported by the web 59 can be moved away from the printing region 52 and removed from the printer and or to a further printing or treatment station.

Where the web 9 is not subject to significant movement and/or sudden reversal of the direction of movement, the festoon arrangement of FIG. 1 may not be required.

In an alternative arrangement of the type of FIG. 3, the length of the printheads in the printing direction is such that the length of the nozzle rows in the printing direction is substantially less than the length of the platen. In this case, the printhead array can be stepped in the printing direction in between scans so that the full length of the substrate can be printed.

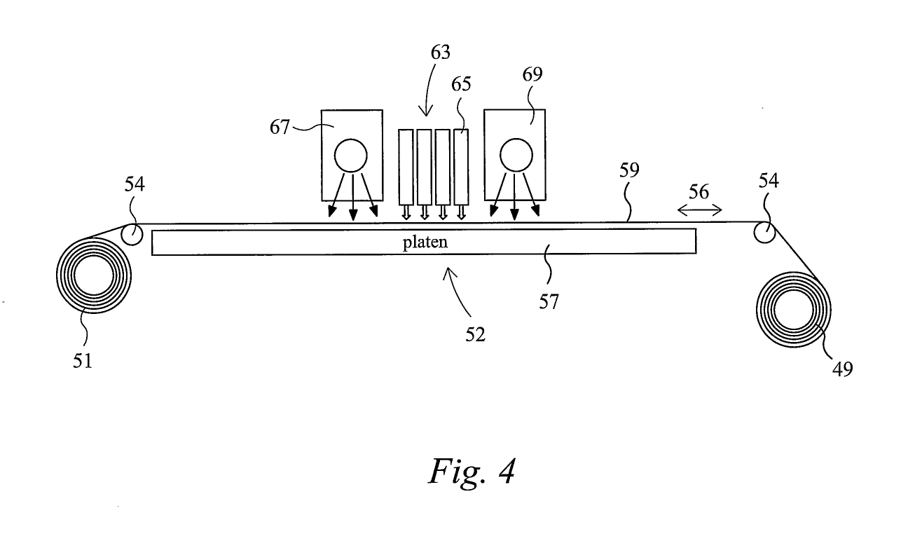

In the arrangement of FIG. 4, the mechanism for the movement of the web 59 is similar to that of FIG. 3. In this arrangement, however, printheads 65 of a printhead array 63 are arranged so that the nozzle rows of the printheads 65 are generally perpendicular to the printing direction 56.

In this arrangement, during printing the printhead arrangement 63 moves in a direction substantially parallel to the printing direction. In the arrangement shown, the width of the nozzle row array of the printheads perpendicular to the printing direction 56 is a little larger than the width of the largest image to be printed using the printer arrangement. In this way, the whole of the image area can be printed in each pass of the printhead arrangement 63 over the substrate. A plurality of passes of the printheads 65 builds up the image to be printed. Alternatively, the image may be printed in a single pass.

Where the image is built up in a plurality of passes, the printhead arrangement is indexed between passes in a direction substantially perpendicular to the printing direction 56. In this way, the full image grid can be printed, and/or the risk of printing artefacts in the image due to for example nozzle defects, can be reduced.

After the image has been printed, the web 59 is advanced to take the next substrate to the printing region 52. As discussed in relation to FIG. 3, the image may be printed directly onto the web 59 and/or onto a substrate object mounted on the web 59. For example, the printer arrangement may be used to print an image onto rigid panels supported by the web 59. As the printed substrate is advanced away from the printing region 52 by the moving web 59, a new substrate is arranged on the web 59 for transport into the printing region 52 adjacent the platen 57.

It will be seen that in this arrangement, the length of the image which can be printed is limited only by the platen length (although there might be some movement of the web during printing to allow for substrates longer than the platen length to be printed as described in FIG. 1. However, the printed length will often be limited by the distance from between the reels 49 to 51. In particular where the image is only partially cured between scans, the printed surface of the image must not be rolled into the web on the reels.

In this arrangement, a large movement of the printhead arrangement is required to perform the print passes and two axes of movement of the printheads are required for the indexing to be carried out. This can give a complex and expensive printhead mounting arrangement. However, accurate printing on the substrate can be achieved. Because the image is built up in layers, printing artefacts due to printing of multiple swathes across the image can be avoided. Also, the printing and curing parameters can be controlled layer by layer to give the desired quality of image, for example gloss level.

In the arrangement of FIGS. 3 and 4, it is seen that the radiation sources 67, 69 are carried with the printhead arrangement 63. This may be on the same or a different frame. Alternatively, or in addition, a fixed curing station may be provided, for example at the end of the platen 57 so that the ink layers can be cured as the printed image passes out of the printing region 52 at the end of the printing operation.

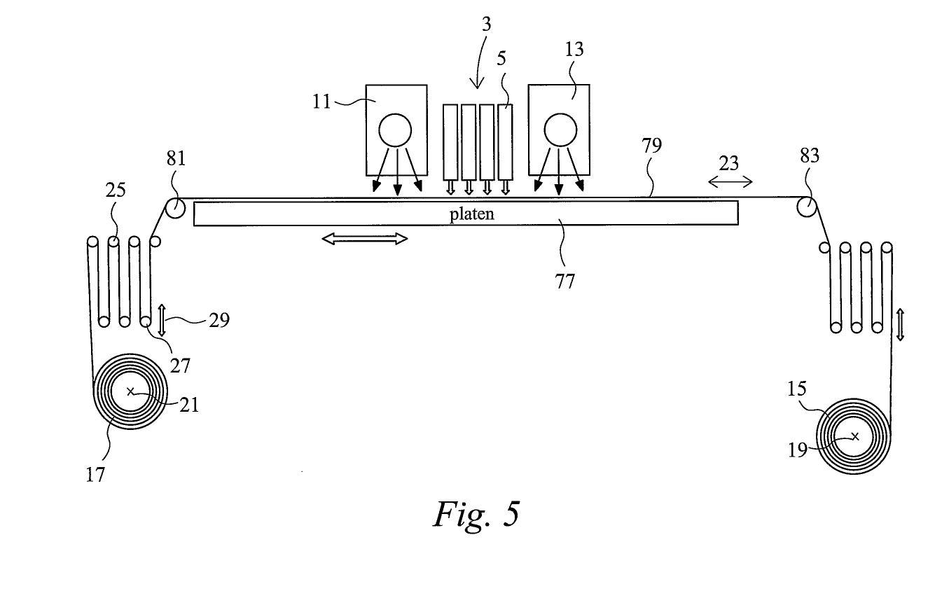

The arrangement shown in FIG. 5 is a variation of the arrangement described in relation to FIG. 1. Corresponding components are referred to using like reference numbers.

In the arrangement of FIG. 5, the printhead arrangement 3 is arranged so that the nozzle rows of the printheads 5 are generally perpendicular to the printing direction 23. Radiation sources 11, 13 are arranged upstream and downstream of the printhead arrangement 3. The printhead arrangement is generally stationary in the printing direction, but is able to step in a direction generally perpendicular to the printing direction 23.

In an arrangement similar to that of FIG. 1, a web 79 passes between two reels 15, 17 mounted for rotation on spindles 19, 21. As one or other of the reels 15, 17 is wound up, the web 79 passes in a printing direction 23 between the reels 15, 17. Festoon arrangements 25 are provided adjacent each of the reels 15, 17 to allow for quick reversal of the movement of the web 79 without spinning the heavy reels up and down.

The significant difference between the arrangement of FIG. 1 and that of FIG. 5 is that in FIG. 5 a long platen 77 is provided being significantly longer in the printing direction than the length of the printhead arrangement in that direction. The web 79 extends along the upper surface of the platen 77 guided by guide rollers 81, 83 to the festoons.

During printing, as in the arrangement of FIG. 1, the printhead arrangement 3 is substantially stationary relative to the printing direction and the web is moved in the printing direction 23 by activating the spindles 19, 21 to drive the reels 15, 17 backwards and forwards.

However, unlike the arrangement in FIG. 1, in the FIG. 5 apparatus, the platen 77 moves with the web 79 so that there is substantially no movement between the web 79 and the platen 77 during the printing of the image. Preferably the movement of the platen 77 is coupled to the movement of the web 79.

FIG. 5 shows the web shortened for illustration. At 85, the web extends to a greater distance between the guide rollers 81, 83 and the printhead arrangement 3 so that the length of the web extending between the guide rollers 81, 83 is approximately twice the length of the platen 77.

Preferably the printhead arrangement 3 is positioned approximately midway between the guide rollers 81, 83.

During printing, the web 79 is preferably held to the platen 77, for example using a suction source. For example, the upper surface of the platen may include a plurality of apertures through which a vacuum is applied to hold the web to the platen 77.

Thus the platen 77 is moved with the web 79 during the printing operation. The web 79 can be moved relative to the platen 77 once the printing operation has been completed to unload the printed substrate from the platen and to load the next substrate for printing onto the platen 77.

An example printing operation for printing an image on a region of the web may be as follows:
a) move platen 77 to immediately adjacent guide roller 81;
b) activate spindle 19 to rotate reel 15 to wind the web 79 onto the reel 15 to move the substrate to be printed onto the platen 77;
c) Apply vacuum to hold web 79 to platen 77. At this point the printhead arrangement will be positioned at the far end of the platen 77 remote from the guide roller 81.
d) A first printing pass is carried out. The printheads 5 are activated to eject ink from the printhead nozzles while spindle 19 is activated to drive reel 15 to wind the web 79 onto reel 15. Thus the web 79 is moved left to right in the printing direction 23 as shown in FIG. 5. The movement of the spindle 19 is coupled to the platen movement mechanism so that there is no relative movement of the web 79 and the platen 77 during printing. The platen 77 and 79 are moved together until the platen is adjacent to the other guide roller 83 and/or the printhead arrangement 3 is at the end of the platen 77 remote from the guide roller 83. During this printing pass, the downstream radiation source 11 is activated so that the deposited ink is partially cured or set. Thus a first layer of ink is deposited over the full image area on the substrate;
e) The printhead arrangement 3 indexes in a direction perpendicular to the printing direction 23 and a second printing pass is carried out. The printheads 5 are activated to eject ink from the printhead nozzles while spindle 21 is activated to drive reel 17 to wind the web 79 in the reverse direction onto reel 17. The platen 77 moves back towards the guide wheel 81 to a position at which the printhead arrangement 3 is at the end of the platen 77 remote from the guide wheel 81 and/or an edge of the platen 77 reaches close to guide roller 81. During the printing pass, the downstream radiation source, in this pass source 13 of FIG. 5, effects a partial cure of the second pass of deposited ink.
f) As required, further printing passes are carried out as indicated above for the first and second printing pass. During all of the passes, the movement of the platen 77 matches that of the web 79 and the web 79 is held to the platen by the application of the vacuum.
g) Once all of the printing passes have been completed, one or two further passes may be made without the printheads emitting ink but with one or both of the radiation sources 11, 13 effecting further cure of the deposited ink.
h) When all the ink has been cured, the vacuum holding the web to the platen 77 is released and the web 79 is moved relative to the platen 77 by activation of spindle 17 and/or 19 to move the printed substrate away from the platen and to move the next substrate to be printed onto the platen 77.

The ink may be deposited directly onto a surface of the web 79 and/or onto a substrate supported by the web 79. For example, the substrate may comprise a rigid board which is supported by the web 79 during printing and is conveyed into and away from a printing region by the web between printing operations.

Since the web and/or the substrate is held to the platen 77 during the printing of the image, markers on the web for use in tracking of the position of the web in the printer may not be required. The position of the web relative to the printheads can be determined in many examples can be determined by reference to the position of the platen 77 since the web 79 is held to the platen 77 during the printing operation.

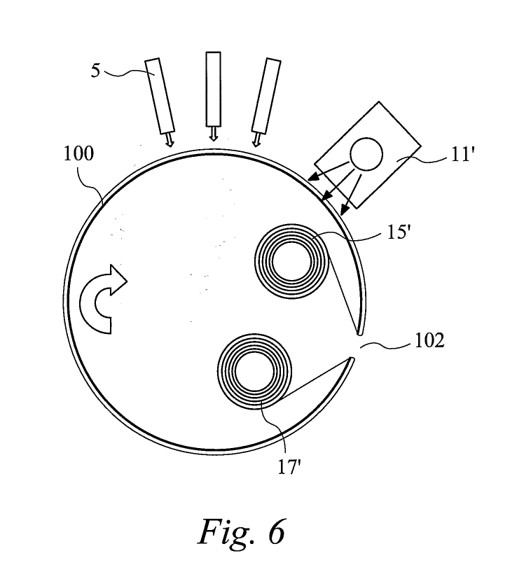

FIG. 6 shows a further example of an arrangement of supporting a web to be printed and/or a web on which substrate to be printed is mounted.

The arrangement includes a cylindrical drum 100 inside which two reels 15′, 17′ are mounted. The reels extend substantially the full length of the cylindrical drum and are mounted on spindles respectively which are arranged parallel to the longitudinal axis of the cylinder and are arranged to effect rotation of the reels 15′, 17′ during the operation of the printer. The drum 100 itself is arranged so as to be rotatable around a central longitudinally extending axis. As the drum 100 rotates, the reels 15′, 17′ and associated mechanism rotate also.

A slit 102 is formed through the surface of the drum and extends substantially the full length of the cylinder, substantially parallel to the longitudinal axis. A web is wound from one reel 15′, out through the slit 102, around the external surface of the drum 100 and back in through the slit 102 to the other reel 17′. By rotating one or both of the reels 15′, 17′, the web can be translated across the exterior surface of the drum 100.

A set of printheads 5 is arranged extending radially around the circumference of the drum 100. A radiation source 11′ for effecting at least partial cure of the printed substance, for example ink, is shown mounted adjacent to the printheads 5. A further radiation source could be provided on the other side of the printheads 5 so that bidirectional curing can be provided.

The printhead set 5 might extend the full length of the drum 100, or only a part of its length, in which case movement of the printheads 5 will be required to effect printing in respect of the full drum surface. Similarly, the radiation source might extend all of part of the length of the drum 100.

The printhead nozzle rows could be arranged parallel to the axis of rotation of the drum 100 or at a different angle.

Various methods could be used to effect printing in this arrangement. Some of these methods correspond to methods and arrangements described above in relation to FIGS. 1 and 3 to 5.

For example, the printing operation might comprise multi pass printing. This can be achieved by rotating the drum 100 in one direction for multiple rotations and/or by rotating the drum 100 in one direction and then an opposite direction on a subsequent pass. The web on the rollers 15′, 17′ can be indexed or moved around the drum 100 as appropriate.

For example, the web might be kept stationary with respect to the drum 100 during printing, the printheads being indexed in an axial direction to build up the printed image. When the printing and curing (if required) of the deposited ink is complete, the web is advanced.

In arrangements where the printhead nozzles extend substantially the full printable length of the drum 100, preferably the image is build up in printed layers rather than swathes, for example. In this way, the parameters of the printing, for example the cure parameters, can be varied for each layer built up, reducing the risk of print artefacts and allowing close control of aspects of the printed image, for example gloss levels.

The nozzle rows could be arranged parallel to the drum axis, or the nozzle rows could be at an angle to the drum axis. The length of the nozzle rows in the drum axis direction might be less than the length of the drum.

The printer might be arranged to carry out printing of the substrate on the drum in a helical path, for example as described in International Patent Application No. WO03/002349.

Such an arrangement can give rise to a compact and fast substrate handling apparatus.

In relation to this and other examples or aspects described herein, the printed image might be built up in layers. Parameters of printing of those layers, for example regarding the curing method, can be varied and controlled for each layer giving desirable features of the printed image. The content of UK Patent Application No. 0707827.2 is incorporated herein by reference.

It will be understood that the present invention has been described above purely by way of example, and modification of detail can be made within the scope of the invention.

Each feature disclosed in the description, and (where appropriate) the claims and drawings may be provided independently or in any appropriate combination.

In summary, apparatus is described for handling a print substrate in a printer. In examples described, the substrate is a web, for example a continuous web. A web support device is provided for supporting the web in a printing region and a web transport device is adapted to move the web forwards and backwards in the printing region. In examples described, multipass printing is carried out.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A substrate handling device for a printer including a printhead arrangement for printing onto the substrate in a printing region,
wherein the substrate includes a web, and the device further includes a web support device for supporting the web in the printing region, and
a web transport device adapted to move the web forwards and backwards in the printing region.

2. A device according to claim 1, wherein the transport device includes two reels, such that in use, the web is wound onto the two reels and extends between the two reels through the printing region, wherein rotation of a reel effects forwards and/or backwards movement of the web in the printing region.

3. (canceled)

4. A device according to claim 1 further including a tracking device for determining information relating to the movement of the substrate in the printing region.

5. A device according to claim 1, wherein the device is adapted for use in a multipass printing method.

6. A device according to claim 1, wherein the web transport device is adapted to move the web a distance corresponding to the length of the image to be printed in a single pass.

7. A device according to claim 1, wherein the transport device further includes a resilient support member.

8. A device according to claim 1, wherein the web support device is adapted such that the web is generally flat in the printing region.

9. (canceled)

10. A device according to claim 1, wherein the web transport device is adapted to move the web backwards and/or forwards during the printing of ink onto the substrate.

11. A device according to claim 1, wherein the web support device includes a platen in the printing region and wherein the platen extends a length being substantially the image length in the direction of movement of the substrate.

12. A substrate handling device for a printer including a printhead arrangement for printing onto the substrate in a printing region wherein the substrate includes a continuous web, the device including:
a web support device for supporting the web in the printing region, the web support device comprising a support element having a support surface for supporting the substrate, and
web transport device adapted to move the web through the printing region in a printing direction.

13. A device according to claim 12, wherein the support surface comprises the surface of a drum.

14. (canceled)

15. A device according to claim 12, wherein the support surface extends substantially the full image length in the printing direction.

16. A device according to claim 12, wherein the length of the support surface is significantly longer than the length of the printhead array in the printing direction.

17. A device according to claim 12 further including a printhead arrangement, wherein the printhead arrangement is adapted to be moved in the printing direction.

18. A device according to claim 17 wherein the printhead arrangement includes a plurality of nozzles, the nozzles being arranged in a substantially continuous array in a direction substantially perpendicular to the printing direction.

19. A device according to claim 13, wherein the support surface comprises a drum wherein the printable drum circumference is substantially the printed image length.

20. A device according to claim 1 being incorporated into a printer.

21. A device according to claim 20, wherein the printer is an inkjet printer.

22.-23. (canceled)

24. A method of printing onto a substrate comprising a continuous web, the method including supporting the web in a printing region, and moving the web forwards and backwards in the printing region.

25. (canceled)

26. A method according to claim 24, including moving the web during printing.

27.-34. (canceled)
